(19) United States
(12) Patent Application Publication
(10) Pub. No.: US 2026/0131557 A1
(43) Pub. Date: May 14, 2026

(54) NON-WOVEN BIODEGRADABLE STRAW MATS

(71) Applicant: YEDA RESEARCH AND DEVELOPMENT CO., LTD., Rehovot (IL)

(72) Inventor: Jonathan GRESSEL, Rehovot (IL)

(21) Appl. No.: 19/497,253

(22) PCT Filed: Jun. 26, 2024
(86) PCT No.: PCT/US2024/035498

§ 371 Date: Dec. 25, 2025

Related U.S. Application Data
(60) Provisional application No. 63/523,551, filed on Jun. 27, 2023.

(51) Int. Cl. B32B 9/04; B32B 9/02

(52) U.S. Cl. CPC B32B 9/045; B32B 9/02; B32B 2250/03; B32B 2317/00; B32B 2367/00; B32B 2375/00; B32B 2410/00

(57) ABSTRACT

Methods for producing fully biodegradable straw mats for use with aquaponic systems, for soil erosion control, for weed mitigation, for controlled release fertilization, for packaging; for building construction insulation; and for other industrial and agricultural purposes.

### CROSS-REFERENCE TO RELATED APPLICATION

This application claims the benefit of priority of U.S. Provisional Patent Application Ser. No. 63/523,551 entitled GENERATION OF BIOBASED, NON-WOVEN STRAW MATS FOR MULTIPLE GREEN USES, filed on Jun. 27, 2023, the contents of which are incorporated herein by reference in their entireties.

### TECHNICAL FIELD

The instant invention pertains to the providing of biodegradable matting produced by combining straw with a biodegradable adhesive; and their use as filters for penned fish, applied to soil for erosion prevention and weed control as well as their use as a packaging material and insulation. Further industrial, medical and scientific uses of the instant invention should be appreciated from the following description and disclosure.

### BACKGROUND OF THE INVENTION

About half of above ground grain crop biomass is wasted: that is, the dried stalks or stems that bore the grain. Most of the world's two billion tons of rice, wheat, and maize straw produced annually have a negative economic value and negative ecological impact in the world. Much of the above ground grain crop biomass typically had been burnt after harvest until environmental rules predominantly prohibited this practice, necessitating use of fungicides to control residual pathogens or excess cultivation to bury the straw.

Straw temporarily binds mineral nutrients if and after being plowed-under, often requiring additional fertilizer for a successful following crop. This excess fertilizer also has negative economic impact and environmental consequences due to wastage, runoff and contamination of water.

Small amounts of straw are fed to ruminants as roughage or as an extender or filler to animal feeds; however, very little caloric value is derived from straw itself., as most of what remains in straw by harvest time are hemicelluloses (mainly xylans) and cellulose, but their enzymatic biodegradation is heavily prevented by a smaller component of lignin and thus are of little nutritional value (Gressel, Vered et al. 1983).

### Straw Use in Aquaculture

As may be appreciated, the industrial aquaculture of fish results in the large-scale production of fish excrement. These excrements of caged farmed fish, pollute surrounding waters; and become a waste of utilizable mineral nutrients.

The soluble wastes of large scale intensive on-land aquaculture fisheries are typically filtered through sophisticated systems which utilize bacteria on beads to denitrify ammonia and urea to dinitrogen gas (Shnel, Barak et al. 2002), a loss of the considerable energy used to produce urea and ammonia.

Straws and other agricultural wastes are added to some fishponds to absorb urea and ammonia; typically via a biofilm of periphyton bacteria and fungi that grows on the straw using the inherent lignin and carbohydrates from the straw itself as their carbon source; together with the bound ammonia, nitrates and soluble phosphorous emanating from the fish excretions as sources of nitrogen and phosphate, thus providing a complete medium for periphyton growth (Umesh, Shankar and Mohan 1999, Mridula, Manissery et al. 2005, Thomas, Lalramchhani et al. 2020). Fish directly consume the periphyton or indirectly via crustaceans and other zooplankton which derive their nutrition from the periphyton, thus requiring less exogenous feeding (Rai, Yi et al. 2008).

Tragically, there has been no cost-effective solution to prevent the pollutive runoff from fish penned in cages into open bodies of water (that is; lakes, rivers, seas, and oceans).

### Bio-Adhesives

There is vast literature related to the production of biobased adhesives that are themselves biodegradable. The market for such products is broad and large (Anonymous 2022).

The bio-adhesive lignin was first mentioned in 1813 by the Swiss botanist A. P. de Candolle, who described it as a fibrous, tasteless material, insoluble in water and alcohol but soluble in weak alkaline solutions, and which can be precipitated from solution using acid. He named the substance “lignine”, which is derived from the Latin word lignum, meaning wood. Lignin is one of the most abundant organic polymers known, exceeded only by cellulose and chitin.

Publications describing adhesives based on waste lignin products are known, (Frazier 2023) (Yang, Gong et al. 2023, Mili, Hashmi et al. 2022) along with lignin composites with glyoxal (Siahkamari, Emmanuel et al. 2022), polyurea (Liu, Fang et al. 2020), as well as epoxy (Li, Gutierrez et al. 2018); all suggesting that these adhesives may be used for gluing wood, especially in plywood production. Despite these publications, few companies are known to commercialize lignin based bio-adhesives.

Other known bioproducts have been modified to enhance their use of adhesives, especially to render them hydrophobic. These include hydrophobic starch for gluing paper (Watcharakitti, Nimnuan et al. 2023), urea-oxidized starch (with nano-titanium dioxide) (Zhao, Peng et al. 2018), polylactic acid (Ranakoti, Gangil et al. 2022), and many others recently reviewed (Nordstrom, Demrican et al. 2018, Antov, Savov and Neykov 2020).

Powdered straws has been graft polymerized with acrylamide to produce 100 mesh particles that absorb 8 times their weight in water (Wan, Huang et al. 2013).

### Straw Mats

Straw mats may potentially be used as a packaging material to replace non-biodegradable synthetic foams and bubble wrap derived from non-renewable hydrocarbons.

Straw mats may also be potentially used as in-wall insulation replacing other non-biodegradable insulation material.

Loose straw enclosed in plastic netting is known in soil erosion control; used on slopes and as a ground cover to prevent weed growth and to save water in agriculture, and the netting eventually degrades to undesirable microplastics. However, such cannot be used as water filters as the straw moves and “sags” within the netting.

Wheat and rice straws are a major crop residue worldwide, however inventively, wheat is preferred over rice straw, as wheat straw has more nutrients available for periphyton growth. Rice straw has a high silica content; and is thus somewhat less appropriate for straw mat filters, but can be used as ground cover, insulation and packaging.

It is an object of the invention to provide an improvement to the existing techniques known in the prior art.

### SUMMARY OF THE INVENTION

### Definition

Straw is herein defined as the residual above ground stem and leaf residue of crop plants remaining after grain or other crop harvest or processing. This includes the residues of cereal grains, dicotyledonous crops, as well as the thicker stem material commonly termed stover from, maize, sorghum and millets. The residual material after pressing sugar cane, commonly termed bagasse is included in the definition of straw in this application as bagasse is anatomically and physiochemically analogous to the other straw types described above.

Fish are defined to be all seafood cultivated in pens.

### Technical Problem

Modernly and globally; most agricultural “bio-waste” such as stalks and stover are typically “sown over” after the harvest of grains, fruits, and vegetables. In some regions; such bio-waste is still simply burnt in the field. Besides the “waste” of the bio-material; negative environmental impact is attached.

### Solution to Problem

It is an object of the instant invention to provide a formable biodegradable mat comprising cross-linked straw bonded with a biodegradable adhesive, the formable mat filter placed to line the bottom and sides of aquaculture fish pens; wherein water is allowed move through the formable mat filter; whereby as the formable biodegradable mat slowly degrades biofilms (periphyton) develop thereon; thereby absorbing urea ammonia from the aquaculture fish pen water.

It is contemplated that in an embodiment of the instant invention, the formable biodegradable mat may be used in an aquaculture environment as a filter, the mat as a filter will become overgrown with biofilms (periphyton) which develop on them, will reduce or prevent movement of parasites and pathogens through the formable biodegradable mat filter while allowing oxygenated water to flow there through to sustain the fish being farmed.

It is an object of the instant invention to provide a biodegradable non-woven, cohesive straw mat or mats of different densities, porosities, and thicknesses with the straw cross-linked using modified lignin and other biodegradable adhesives and mixtures thereof.

Such non-woven mats would not leave plastic residues, and the adhesive would slow the biodegradation of the straw component of the mats, allowing mats to perform their functions for extended durations.

An embodiment of the instant invention is intended for providing formable biodegradable straw mats for use as biofilters used in a water environment.

An embodiment of the instant invention is intended for providing straw mats for use as and for soil erosion mitigation.

An embodiment of the instant invention is intended for providing formable biodegradable straw mats for use as and for soil erosion mitigation and crop seed or transplant placement and protection from weeds while shading the soil and preventing surface soil drying.

An embodiment of the instant invention is intended for providing formable biodegradable straw mats for use as and for crop seed or transplant placement and protection including a soluble fertilizer mixture appropriate for the particular use sprayed onto the straw prior to application of the biodegradable adhesive. Such fertilizer will be slowly released from the mats throughout the cropping season, mitigating fertilizer runoff and contamination of surface and ground waters that occurs with single applications ..

In preferred embodiments the bio-adhesive is hydrophobic and not softened by water (i.e. has suitable wet strength) after drying/curing.

In an embodiment of the instant invention, the bio-adhesive for binding the straw into mats is a modified lignin such as those described in (Li, Gutierrez et al. 2018, Liu, Fang et al. 2020, Mili, Hashmi et al. 2022, Siahkamari, Emmanuel et al. 2022, Frazier 2023, Yang, Gong et al. 2023) as well as commercially available modified lignin such as LIGNOVA™ produced by OU Fibenol, Moisa 4, 13522 Tallinn, Estonia.

In an embodiment of the instant invention, the bio-adhesive for binding the straw into mats is a polylactic acid such as those described (Ranakoti, Gangil et al. 2022) in as well the commercially available modified lignin such as OC BioBinder™ Lily 1450, which is a proprietary adhesive composed of L-(+)-lactic acid and (2S)-2-hydroxypropanoic acid with 1,2 benzisothiazol and 5-chloro-2-methyl-3(2H)-isothiazolone as preservatives produced by OrganoClick AB Linjalvägen 9 SE-187 66 Täby Sweden.

In yet another embodiment of the instant invention the bio-adhesive for binding the straw into mats is a polyurethane such as those described in (Kumar and Pizzi 2019) as well the commercially available ST6515, which is a proprietary adhesive based on polyurethane chemistry with 5-chloro-2-methyl-4-isothiazolin-3-one and 2-methyl-2h-isothiazol-3-one added as preservatives produced by Scitech Adhesives and Coating, Flint, Wales.

In yet another embodiment the instant invention the bio-adhesive for binding the straw into mats is a chitosan such as those described in (Mati-Baouche, Elchinger et al. 2014) or is a chitosan mixed with another adhesive such as in the commercially available LigninTack, which is a water soluble proprietary adhesive composed of lignosulfonate and chitosan produced by Ribler GmbH, Plieninger Straβe 5870567 Stuttgart-Möhringen, Germany.

In another embodiment of the instant the bio-adhesive for binding the straw into mats is a hydrophobic modified starch such as those described in (Nordstrom, Demrican et al. 2018, Zhao, Peng et al. 2018, Antov, Savov and Neykov 2020, Watcharakitti, Nimnuan et al. 2023)

In yet another embodiment of the instant invention the bio-adhesive for binding the straw into mats is a hydrophobic modified cellulose such as those described in (Xu, Yin et al. 2024)

In yet another embodiment of the instant invention the bio-adhesive is water soluble and can be diluted to a desired viscosity for application of the straw with a commercial sprayer.

In yet another embodiment of the instant invention for producing and providing the inventive bio-degradable straw mats; the following method steps are performed: distributing randomly and evenly straw to a desired thickness and desired dimension; applying a bio-adhesive to the straw in sufficient amount to bind (cross link) the straw together once the bio-adhesive is cured (or dried); and compressing the mixture under heat for a desired time and at a desired temperature until the bio-adhesive is cured; thus producing an/the inventive bio-degradable straw mat.

In an embodiment of the instant invention the bio-degradable mats are placed in a hot press for a short duration at 80-110 C to remove water, to melt the bio-adhesive, to pasteurize the straw, and to cure or dry the bio-adhesive while binding the randomly distributed straw coated with the bio-adhesive; thus producing an/the inventive bio-degradable mat.

In an embodiment of the instant invention, in larger scale industrial embodiments of the instant invention; roller presses analogous to those used in paper mills, or analogous to laminating presses used in the production of plywood, pressed board or Masonite that provide the temperature and pressure needed to cure the bio-adhesive coated straw into mats.

In an embodiment of the instant invention where the inventive bio-degradable mat use is as biofilters for aquaculture penned fish systems, the thickness of the mat would be 1 to 5 cm, with a preferred thickness of 1.5-2.5 cm, and contain 5-25% w/w bio-adhesive (depending on the particular bio-adhesive used) to provide a desired mat stiffness yet allowing sufficient water to flow therethrough.

In an embodiment of the instant invention where the bio-degradable mat use is as and for insulation, the thickness of the mat would be 8 to 15 cm with a preferred thickness of 9.5 cm for the mats to be used between standard 10 cm wide wall studs or other thickness as desired for particular construction uses; and 7.5-15% w/w bio-adhesive (depending on the particular bio-adhesive used) to provide a semi-stiff mat.

In an embodiment of the instant invention where the bio-degradable mat is used as and for insulation used in building construction, and other industries, the instant inventive mats may include a fire retardant, applied to the straw before hot-press, included in the bio-adhesive, or applied directly to previously heat-pressed cured/dried mats.

In an embodiment of the instant invention where the bio-degradable mat is used as and for insulation used in building construction, and other industries, the instant inventive mats may include a fungicide to preclude the growth of molds.

In an embodiment of the instant invention where the bio-degradable mat is used as and for erosion and/or weed control, the thickness of the mats may be 1 to 5 cm with a preferred thickness of 1.5-3.0 cm and contain 5-15% w/w bio-adhesive (depending on the particular adhesive used) to provide a “looser” more flexible and a mat which will biodegrade more quickly.

The other major embodiments are the production of straw mats for agriculture, erosion control, and insulation utilizes all other straw types, including pulverized thick stover to produce a fibrous material.

As depicted in FIG. 1, in an embodiment of the instant invention; the method of producing an instantly inventive bio-degradable mat is to utilize a known t-shirt printer hot press configured to accommodate a 38×38 cm (internal dimensions) form with a non-stick sheet attached to the lower side, in which 250 g of straw spray-coated with a bio-adhesive and covered with another non-stick sheet. The temperature and time pressed would vary according to the bio-adhesive used.

In an embodiment of the instant invention; an inventive bio-degradable straw mat used as and for a bio-filter filter may be made using 13% w/w OC BioBinder™ Lily 1450 polylactic acid-based bio-adhesive.

It is however, clear to one skilled in the art that these embodiments are not exclusive or limiting and in specific situations or uses, with different straw types, or adhesives, modifications may be required.

### BRIEF DESCRIPTION OF THE DRAWINGS

FIG. 1 depicts a prototype hot-press configured for curing or drying inventive bio-degradable straw mats.

FIGS. 2A-2C depict inventive bio-degradable straw mats using various commercially available biodegradable-adhesives.

FIG. 3 depicts an inventive biodegradable straw mat soaked in water while maintaining most of its shape structure-in this case a filter mat made using 13% w/w OC BioBinder™ Lily 1450 polylactic acid based bio-adhesive.

### DETAILED DESCRIPTION OF THE INVENTION

The instant inventive subject matter may be understood more readily by reference to the following detailed description in connection with the accompanying Figures and Examples.

In embodiments of the invention, a method of manufacturing a biodegradable straw mat is provided which includes: providing straw; providing a biodegradable adhesive; providing a system of providing heat under pressure; applying the biodegradable adhesive to the straw; placing the straw with applied biodegradable adhesive in a desired random pattern into the system of providing heat under pressure; pressing the straw under heat, thereby flattening and cross-linking the straw and curing the biodegradable adhesive to produce the biodegradable straw mat.

In certain embodiments, the step of pressing the straw is for a desired pressure, time and at a desired temperature until the bio-adhesive is cured.

In certain embodiments, the step of providing the straw involves distributing randomly and evenly the straw into the system of providing heat under pressure at a desired thickness and desired dimension and desired pressure.

In certain embodiments, the desired temperature is 80-110 degrees Celsius removing water from the straw and curing the adhesive.

In certain embodiments, a biodegradable straw mat is provided including straw and a biodegradable adhesive, the biodegradable straw mat having a thickness ranging from 1 to 5 cm and contains 5-25% w/w bio-adhesive.

In certain embodiments, preferably the thickness of the biodegradable straw mat is 1.5-2.5 cm.

In certain embodiments, the biodegradable straw mat is used as a biofilter for aquaculture penned fish systems.

In certain embodiments, the biodegradable straw mat has sufficient mat stiffness yet allows water to flow therethrough.

In other embodiments of the invention, a biodegradable straw mat for use is as and for insulation is provided including straw and a biodegradable adhesive, the biodegradable straw mat having a thickness ranging from 8 to 15 cm and contains 5-25% w/w bio-adhesive.

In certain embodiments, preferably the thickness of the biodegradable straw mat is of 9.5 cm for the mats to be used between standard 10 cm wide wall studs or other thickness as desired for particular construction uses.

In certain embodiments, preferably the biodegradable straw mat contains 7.5-15% w/w bio-adhesive.

In other embodiments of the invention, a biodegradable straw mat for use is as and for weed control is provided including straw and a biodegradable adhesive, the biodegradable straw mat having a thickness ranging from 1 to 5 cm and contains 5-25% w/w bio-adhesive.

In certain embodiments, the thickness of the biodegradable straw mat is 1.5-3.0 cm.

In certain embodiments, preferably the biodegradable straw mat contains 5-15% w/w bio-adhesive.

In certain embodiments, the biodegradable straw mat is “looser” more flexible and a mat which will biodegrade more quickly.

In other embodiments of the invention, a biodegradable straw mat for use is as and for a bio-filter is provided including straw and a biodegradable adhesive, the biodegradable straw mat having a thickness ranging from 1 to 5 cm and contains 5-25% w/w bio-adhesive

In certain embodiments, the bio-adhesive is 13% w/w OC BioBinder™ Lily 1450 polylactic acid-based bio-adhesive.

In certain embodiments, the biodegradable straw mat is used for soil erosion mitigation.

In certain embodiments, the biodegradable straw mat is used for weed killing and weed control.

In certain embodiments, the biodegradable straw mat further includes a fungicide.

In certain embodiments, the biodegradable straw mat is configured for use as and for construction insulation.

In certain embodiments, the biodegradable straw mat further includes a plurality of seeds and appropriate fertilizer used as and for germinating and establishing the seeds in soil or other growing substrate.

In certain embodiments, the biodegradable adhesive comprises a biodegradable organic polymer or a mixture of such polymers.

In certain embodiments, the biodegradable adhesive comprises lignin or derivative thereof.

In certain embodiments, the biodegradable adhesive comprises a polylactic acid.

In certain embodiments, the biodegradable adhesive comprises a polyurethane.

In certain embodiments, the biodegradable adhesive comprises a chitosan.

In certain embodiments, the biodegradable adhesive comprises cellulose.

In certain embodiments, the biodegradable adhesive is hydrophobic.

In certain embodiments, the biodegradable adhesive is water soluble prior to curing.

In certain embodiments, the system of providing heat under pressure is a hot press, static type press, or roller press.

In other embodiments of the invention method of filtering aquaculture system water using the biodegradable straw mat is provided where the biodegradable straw mat is placed within an aquaculture system, thereby absorbing urea and ammonia from the aquaculture system water.

In certain embodiments, biofilms (periphyton) develop of the biodegradable straw mat.

In certain embodiments, the biofilms growing on straw mats are accessible by fish in the aquaculture system as a food source.

### EXAMPLES

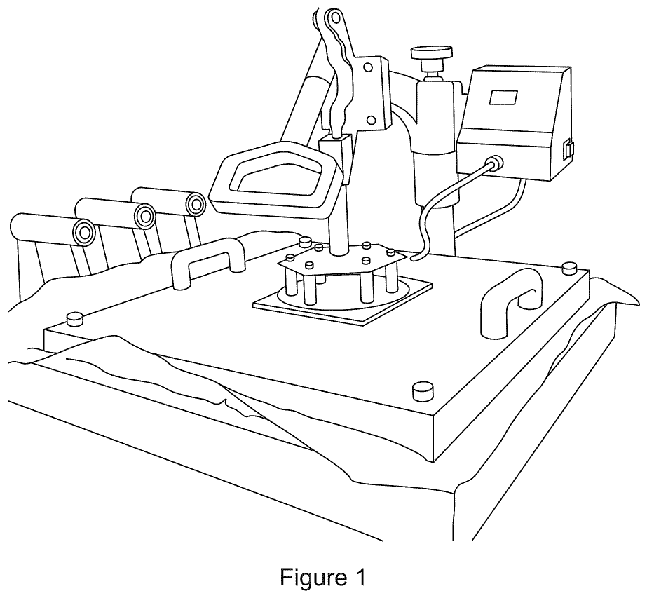

In Examples 1-3 variable amounts of bio-adhesive were applied to 250 g of dry wheat straw, either with a paint sprayer after diluting the bio-adhesive to an acceptable viscosity, or by pouring slowly onto the straw under continual mixing. The straw was placed in a 5 cm deep 38×38 cm (internal dimensions) wood frame with a sheet of polytetrafluoroethylene (PTFE) secured to the base of the frame. The straw in the frame was covered with a fitted sheet of PTFE or fiberglass. The frame was placed on the stage of a commercial heat press that was modified to hold the frame (FIG. 1), and then heated at the temperature and duration as noted in these examples.

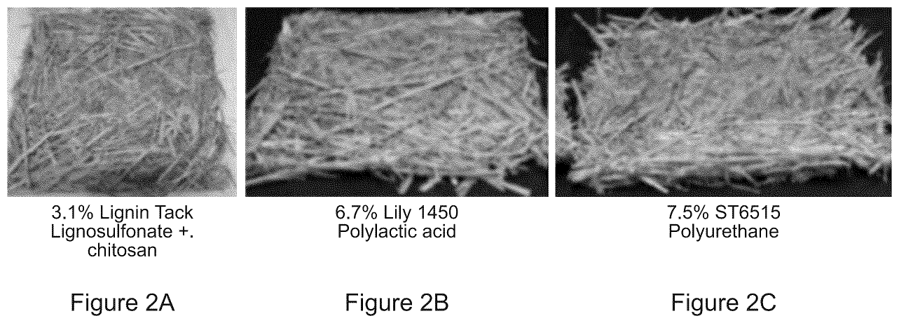

### Example 1. FIG. 2A

Manufacture of lignin/chitosan bonded cross-linked straw mats using commercially available LigninTack, a water soluble proprietary adhesive composed of lignosulfonate and chitosan produced by Ribler GmbH, Plieninger Straβe 5870567 Stuttgart-Möhringen, Germany. LigninTack has a solid content of 9.2%. After mixing the adhesive with straw, the mixture is heat-pressed at 110 C for one hour to evaporate the water, bonding the straw. Mats made with a 5.1% w/w Lignin-Tack adhesive loosely bond are sufficient for use as soil cover. Higher concentrations provide greater mat stiffness appropriate for packaging, aquafilters and insulation.

### Example 2. FIG. 2B

Manufacture of polylactic acid bonded cross-linked straw mats using commercially available OC BioBinder™ Lily 1450, a proprietary adhesive composed of L-(+)-lactic acid, (2S)-2-hydroxypropanoic acid with 1,2 benzisothiazol and 5-chloro-2-methyl-3(2H)-isothiazolone with 2-methyl-3(2H)-isothiazolone as preservatives is produced by OrganoClick AB Linjalvägen 9 SE-187 66 Täby Sweden. OC BioBinder™ has a solid content of ca. 28%. Treated straw was subjected the heat press for 1 hour at 150° C. Two concentrations 17% w/w and 31% w/w of the OC BioBinder™ Lily 1450 polylactic acid based adhesive showed sufficient stiffness for a variety of uses including biofilters for placing on fish cages. Filters made with 6.7% (FIG. 2) were looser and would be appropriate for soil cover.

### Example 3. FIG. 2C

Manufacture of polyurethane bonded cross-linked straw mats using commercially available ST6515, a proprietary adhesive based on polyurethane chemistry with 5-chloro-2-methyl-4-isothiazolin-3-one and 2-methyl-2h-isothiazol-3-one added as preservatives produced by Scitech Adhesives and Coating, Flint, Wales. The adhesive had a solid content of 40%. The mixture was subjected to 150° C. heat treatment for 1 H in the heat press. This adhesive can be used without heating, but we found that more compact mats were formed in the heat press with heating. Filters made with 3% w/w adhesive were looser and would be appropriate for soil cover. Filters made with 7.4% (FIG. 2) had the stiffness required for aquaculture filters.

### Example 4

Assay to ascertain ability to remain intact in water and pass water freely.

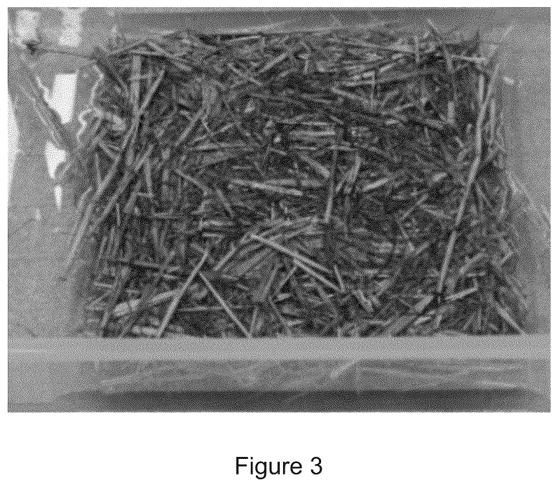

Poured water readily ran through mats described in Example 1-3 showing that the mats are not a complete impediment to water movement and thus they have a potential as filters. Wet strength was crudely measured by placing the filters, weighted down, in water for 5 days. The filter types described in Examples 1-3 maintained their structure when submerged in water for 5 days (FIG. 3).

### Example 5

Laboratory scale testing of mats as biofilters for aquaculture.

A series of five aquariums were set up; three with the filters described in Example 1-3; one with a standard carbon filter along with denitrifying pellets on the side and one with no filter at all. A 150 liter/h aquarium pump was installed in each aquarium. In the three with filters the pump continually recirculates the water from the left chamber to the right chamber with water in the right chamber flowing through the filter to the left chamber. A similar pump passed the water to the side conventional filter and the water return to the aquarium by gravity. The pump in the fifth aquarium just recirculates the water. An equal number of fish is introduced into all aquariums, with half the number in each side of the experimental aquariums with inventive straw mat filters. The fish are fed a sub-optimal diet to demonstrate that those in the straw filter-mat aquariums gained additional weight by ingesting periphyton. The comparative water level on either side of the inventive filter mats is monitored to demonstrate that the filters do not impede water flow. The eventual demise of the fish in the aquarium without any filtration system, and the superior continued growth of the fish with the straw mat filters demonstrates the effectiveness and utility of this instant invention.

### Example 6

Small scale demonstration of prevention of weed emergence through the inventive straw mats of the types described in Examples 1-3. An 50×150 area of soil prepared for sowing was heavily/evenly seeded with weed seeds. Inventive mats of the types described in Examples 1-3 were immediately placed on the soil and a small hole made in the center of each mat and tomato plants transplanted through the holes in each and the area watered continuously throughout the duration of the experiment. Weeds emerged around the periphery of the mats, but not through the inventive mats themselves.

### Example 7

Inventive mats for use as insulation are tested by an accredited testing laboratory to ascertain they meet the requires specifications using the most appropriate of the following protocols for each specific use:
ASTM C390-08(2024)—Standard Practice for Sampling and Acceptance of Thermal Insulation Lots https://www.astm.org/c0390-08r24.html
ASTM C930-19—Standard Classification of Potential Health and Safety Concerns Associated With Thermal Insulation Materials and Accessories https://www.astm.org/c0930-19.html
ASTM C303-21—Standard Test Method for Dimensions and Density of Preformed Block and Board-Type Thermal Insulation https://www.astm.org/c0303-21.html
ASTM C1114-06(2019)—Standard Test Method for Steady-State Thermal Transmission Properties by Means of the Thin-Heater Apparatus. https://www.astm.org/c1114-06r19.html
ASTM C1919-22—Standard Practice for Measurement of the Steady-State Thermal Transmission Properties of Small Specimens Using the Heat Flow Meter Apparatus https://www.astm.org/c1919-22.html
ASTM C1373/C1373M-23—Standard Practice for Determination of Thermal Resistance of Attic Insulation Systems Under Simulated Winter Conditions https://www.astm.org/c1373_c1373m-23.html

In the foregoing description, numerous details are set forth for the purpose of explanation. However, one of ordinary skill in the art will realize that the invention may be practiced without the use of these specific details.

1. A method of manufacturing a biodegradable straw mat comprising the steps of:
providing straw;
providing a biodegradable adhesive;
providing a system of providing heat under pressure;
applying the biodegradable adhesive to the straw;
placing the straw with applied biodegradable adhesive in a desired random pattern into the system of providing heat under pressure;
pressing the straw under heat, thereby flattening and cross-linking the straw and curing the biodegradable adhesive to produce the biodegradable straw mat.

2. The method of claim 1, wherein the step of pressing the straw is for a desired pressure, time and at a desired temperature until the bio-adhesive is cured.

3. The method of claim 1, wherein the step of providing the straw involves distributing randomly and evenly the straw into the system of providing heat under pressure at a desired thickness and desired dimension and desired pressure.

4. The method of claim 1, wherein the desired temperature is 80-110 degrees Celsius removing water from the straw and curing the adhesive.

5. A biodegradable straw mat comprising straw and a biodegradable adhesive, the biodegradable straw mat having a thickness ranging from 1 to 5 cm and contains 5-25% w/w bio-adhesive.

6. The biodegradable straw mat of claim 5, where the thickness of the biodegradable straw mat is 1.5-10 cm.

7. The biodegradable straw mat of claim 5, wherein the biodegradable straw mat is used as a biofilter for aquaculture penned fish systems.

8. The biodegradable straw mat of claim 5, wherein the biodegradable straw mat has sufficient mat stiffness yet allows water to flow therethrough.

9. A biodegradable straw mat for use is as and for insulation, comprising straw and a biodegradable adhesive, the biodegradable straw mat having a thickness ranging from 8 to 15 cm and contains 5-25% w/w bio-adhesive.

10. The biodegradable straw mat of claim 9, where preferably the thickness of the biodegradable straw mat is of 9.5 cm for the mats to be used between standard 10 cm wide wall studs or other thickness as desired for particular construction uses.

11. The biodegradable straw mat of claim 9, where preferably the biodegradable straw mat contains 7.5-15% w/w bio-adhesive.

12. The biodegradable straw mat of claim 5, wherein the biodegradable straw mat is for use is-as and for weed control.

13. The biodegradable straw mat of claim 12, where preferably the thickness of the biodegradable straw mat is 1.5-3.0 cm.

14. The biodegradable straw mat of claim 12, where preferably the biodegradable straw mat contains 5-15% w/w bio-adhesive.

15. The biodegradable straw mat of claim 12, where the biodegradable straw mat is “looser” more flexible and a mat which will biodegrade more quickly.

16. (canceled)

17. The biodegradable straw mat of claim 5, wherein the bio-adhesive is a 5 -15% w/w polylactic acid-based bio-adhesive.

18. The biodegradable straw mat of claim 5, wherein the biodegradable straw mat is used for soil erosion mitigation, weed killing and weed control, or for construction insulation.

19. (canceled)

20. The biodegradable straw mat of claim 5, wherein the biodegradable straw mat further includes a fungicide or a plurality of seeds and appropriate fertilizer used as and for germinating and establishing the seeds in soil or other growing substrate.

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. The biodegradable straw mat of claim 5, wherein the bio-adhesive is a 5-15% w/w lignin based adhesive.

36. The biodegradable straw mat of claim 5, wherein the bio-adhesive is a polyurethane based adhesives.
